(19) United States
(12) Patent Application Publication
(10) Pub. No.: US 2018/0171529 A1
(43) Pub. Date: Jun. 21, 2018

(54) CONTROL METHOD OF FLOCCULATION WASHING MACHINE, AND WASHING MACHINE

(71) Applicant: QINGDAO HAIER WASHING MACHINE CO., LTD., Qingdao, Shandong (CN)

(72) Inventors: Sheng XU, Qingdao, Shandong (CN); Jinzhu DENG, Qingdao, Shandong (CN); Dong LI, Qingdao, Shandong (CN)

(73) Assignee: QINGDAO HAIER WASHING MACHINE CO., LTD., Qingdao, Shandong (CN)

(21) Appl. No.: 15/577,547

(22) PCT Filed: Apr. 15, 2016
(86) PCT No.: PCT/CN2016/079407

§ 371 Date: Nov. 28, 2017

(30) Foreign Application Priority Data
May 29, 2015 (CN) 201510290329.0

(51) Int. Cl. D06F 39/02; D06F 33/02; D06F 39/10; C02F 1/52

(52) U.S. Cl. CPC D06F 39/02; D06F 33/02; C02F 2301/04; C02F 1/5209; D06F 39/10

(57) ABSTRACT

A control method of a flocculation washing machine comprises: detecting an amount of washing water V and an amount of a detergent delivered m in a washing procedure to obtain a concentration of the detergent C=m/V; and determining a number of times N of flocculation circulation and a dose Mₙ of a flocculant corresponding to each flocculation circulation according to the concentration of the detergent C. The number of times N of flocculation circulation and the dose Mₙ of the flocculant corresponding to each flocculation circulation can be obtained accurately only based on one parameter. Besides, the flocculation treatment and the rinsing procedure of the washing machine are synchronously executed, and at an end node, the concentration of the detergent in the outer drum is lower than a set value, thereby achieving the purpose of removing detergent residual on clothes.

### TECHNICAL FIELD

The present disclosure relates to a washing machine which performs self-cleaning treatment on water through flocculation in the field of washing machines, particularly relates to a control method of a flocculation washing machine, and further relates to a washing machine adopting the control method.

### BACKGROUND

With the improvement of people's living standards, washing machines have become one of major household appliances in people's daily life. The washing process of a washing machine mainly comprises several stages of washing, rinsing and dewatering. In the washing stage, water and a detergent are fed into the washing machine, and clothes are washed; and after the rinsing stage begins, in order to rinse out dirt and the residual detergent, much water is needed or many times of rinsing needs to be performed to rinse the clothes, so that a large amount of water is consumed. Even if a water-saving drum washing machine is used, the clothes also need to be rinsed at least twice to get cleaned, and at least 30 L or above of running water needs to be consumed in the process. Sometimes, dirt on the clothes is less or the use amount of the detergent is less, the clothes can be cleaned after being rinsed twice, and because a user selects three times of rinsing, waste of water can also be caused. For example, a 6 Kg full-automatic washing machine generally consumes about 100 litres of water for rinsing twice. How to thoroughly wash clothes and save water and electricity at the same time is one of the focuses of consumers.

Therefore, the applicant has filed a Chinese patent application with the application number of 201310356428.5, which relates to a washing machine with a circulating water treatment function and a control method for the washing machine. The washing machine comprises an outer drum, a washing structure arranged in the outer drum and a flocculation water treatment device arranged under the outer drum, wherein the flocculation water treatment device comprises a flocculation treatment unit and a filtering unit, and the flocculation treatment unit comprises a flocculation drum communicating with the outer drum, and a flocculant deliverer for delivering a flocculant into the flocculation drum, and water is discharged from the outer drum to the flocculation drum for flocculation treatment. The filtering unit comprises a filtering container and a filtering screen arranged in the filtering container, the filtering container communicates with the flocculation drum and the outer drum, and water after flocculation treatment in the flocculation drum is filtered and re-discharged into the outer drum for reuse. In this patent application, the flocculation filtration-treated water is circulated until washing is finished, and the water is discharged into the circulating water treatment device for cleaning of the flocculation treatment unit and the filtering unit, and then is drained. The flocculation washing machine provided by this patent application has the characteristics that water is saved, water pollution is reduced, and the environment is protected.

The above washing machine with the circulating water treatment function needs to possess a water treatment process of a common washing machine as follows: the dirt water after washing is discharged from a washing drum to the flocculation drum. After an intake water volume of the flocculation drum reaches a set value, a flocculant is delivered, so that the flocculant reacts with the detergent and the sewage to generate flocculates; the flocculates are filtered out and/or flocculation water stands for stratification, so that clean water is separated from the flocculation water; and the treated clean water flows back to the outer drum to complete once flocculation circulation.

The amount of water in each flocculation circulation treatment is smaller than the total amount of washing water in the outer drum, that multiple times of treatment need to be performed to complete the flocculation treatment of the washing water. Therefore, how to accurately determine the number of times N of flocculation circulation needed by the flocculation treatment process becomes very important.

In addition, it will lead to a poor effect on flocculation or a failure of the flocculation if a dose of the flocculant being used has a relatively larger deviation (the flocculate particles are too small to be effectively stratified when the dose of the flocculant is less, and the density of the flocculates is greater so that it cannot achieve effective stratification when the dose of flocculant is excessive). So the dose of the flocculant in each flocculation circulation must be accurately controlled to prevent the above-mentioned conditions from occurring.

In view of this, the present disclosure is proposed.

### SUMMARY

A technical problem to be solved in the present disclosure is to overcome the defects in the prior art and provide a control method of a flocculation washing machine to achieve an object of accurately controlling a flocculation process.

To achieve the above object of the present disclosure, the basic concept of the technical solution adopted by the present disclosure is:

a control method of a flocculation washing machine comprises: acquiring an amount of washing water V and an amount of a detergent delivered m in a washing procedure to obtain a concentration of the detergent C=m/V; and determining a number of times N of flocculation circulation of the washing water and a dose Mₙ of a flocculant corresponding to each flocculation circulation according to the concentration of the detergent C.

Further, Mₙ includes M₁ which corresponds to the first time of flocculation circulation, M₂ which corresponds to the second time of flocculation circulation, . . . , and Mₙ which corresponds to the Nth time of flocculation circulation. Further, specific steps for determining the number of times N of flocculation circulation and the dose of the flocculant Mₙ delivered corresponding to each flocculation circulation are as follows:

1) Obtaining an amount of the washing water V by a selection of a user and/or a detection of the washing machine, and invoking a corresponding amount V₁ of water treated in each flocculation circulation and an amount V₂ of residual water after treatment and returning; and obtaining a dilution rate μ after each time of flocculation treatment according to μ=(V₁−V₂)/(V−V₂).

2) Obtaining a concentration Cₙ of the detergent in an outer drum after the n-th time of flocculation circulation according to Cₙ=C μⁿ (n is any integer larger than 0);

3) Comparing Cₙ with a set value Cₘᵢₙ to obtain the number of times N of flocculation circulation; and

4) Obtaining a dose of the flocculant delivered in the n-th time of flocculation circulation Mₙ according to Mₙ=(V₁−V₂)*α C μⁿ⁻¹.

Further, the amount V₂ of the residual water after treatment and returning in the flocculation drum does not exist before the very first time of flocculation circulation. Therefore, in step 4), the dose M₁ of the flocculant delivered in the first time of flocculation circulation satisfies M₁=α m V₁/V=V₁α C; and the dose of the flocculant delivered in other times of flocculation circulation is still equal to the dose of the flocculant delivered in the n-th time of flocculation circulation Mₙ=(V₁−V₂)*α C μⁿ⁻¹.

Further, the amount of water treated in flocculation circulation is an amount of water in a flocculation drum during the flocculation treatment. The amount V₁ of water treated in each flocculation circulation is the maximum capacity of the flocculation drum when the amount of the washing water V is larger than a set value. The amount V₁ of water treated in each flocculation circulation is ⅘ to ½ of the maximum capacity of the flocculation drum when the amount of the washing water V is smaller than the set value; and preferably, V₁ is ⅘ of the maximum capacity of the flocculation drum.

Further, the amount V₂ of residual water after treatment and returning is a set value smaller than ½ of the maximum capacity of the flocculation drum; and preferably, V₂ is a set value between 0.5 L and 3 L.

Further, a value Cₙ closest to the set value and smaller than Cₘᵢₙ is determined, and then the number of times N of flocculation circulation is n corresponding to the determined value.

Further, in step 4), α is a corresponding set value according to characteristics of the detergent and the flocculant.

Further, after the washing procedure of the washing machine ends, a rinsing procedure starts running by utilizing the washing water, and simultaneously the washing water is subjected to N times of flocculation circulation, wherein the flocculant is delivered into the flocculation drum in an amount of Mₙ in each flocculation circulation.

Further, a specific working process of the washing machine is as follows:

S1) obtaining an amount of the washing water V and an amount of the detergent delivered m after the washing machine starts running the washing procedure, and obtaining a concentration of the detergent C according to C=m/V;

S2) determining a number of times N of flocculation circulation of the washing water and a dose Mₙ of the flocculant delivered corresponding to each flocculation circulation according to the concentration of the detergent C;

S3) after the washing procedure ends, allowing the washing water in the outer drum to flow into the flocculation drum until the amount V₁ of washing water for flocculation treatment in the flocculation drum is, delivering the flocculant in an amount of Mₙ into the flocculation drum, performing flocculation treatment on the washing water in the flocculation drum, and thereafter allowing water in the flocculation drum to flow back to the outer drum until an amount of residual water in the flocculation drum is V₂;

S4) adding 1 to an accumulated value of the number of times of flocculation circulation, and determining whether the accumulated value reaches N or not; if not, continuously executing step S3) while substituting the accumulated value into step S3) as n; and if yes, executing step S6);

S5) starting running the rinsing procedure by utilizing the washing water in the outer drum while executing step S3) and step S4); and

S6) after the rinsing procedure ends, completely draining out water in the outer drum and the flocculation drum, and cleaning the flocculation drum.

Another object of the present disclosure is to provide a washing machine adopting the above control method. The washing machine is characterized in that: a flow sensor is arranged on a water intake structure of the washing machine and/or a liquid level sensor is disposed in the outer drum to detect an amount of washing water V; and a flow sensor is arranged on an automatic detergent deliverer to detect an amount of a detergent delivered m.

Further, a liquid level sensor is disposed in a flocculation drum and/or a flow sensor is arranged on a pipe, connected with the outer drum, of the flocculation drum to detect an amount of water in the flocculation drum; and a flow sensor is arranged on an automatic flocculant deliverer to detect a dose of a flocculant.

The present disclosure has the following beneficial effects compared with the prior art:

1. By the above modes, the flocculation treatment and the rinsing procedure of the washing machine are synchronously executed, and at an end node, the concentration of the detergent in the outer drum is lower than a set value, thereby achieving the purpose of removing detergent residual on clothes.

2. By the above modes, different flocculation treatment processes matching with different washing procedures are achieved, and the dose of the flocculant delivered are accurately controlled, thereby preventing a condition that flocculates cannot be stratified from occurring. Besides, the number of times of flocculation circulation is also accurately determined, thereby preventing a condition that the detergent is treated incompletely or the number of times of flocculation circulation is excessive to waste electric power from occurring.

3. In the present disclosure, the number of times N of flocculation circulation and the dose of the flocculant delivered corresponding to each flocculation circulation Mₙ can be obtained accurately only based on the concentration of the detergent in the washing procedure, thereby achieving the accurate control on the flocculation treatment process of the washing machine.

4. The control method is simple and brief, has remarkable effects and is suitable for popularization and application.

Specific embodiments of the present disclosure are further described below in detail with reference to the accompanying drawings.

### BRIEF DESCRIPTION OF THE DRAWINGS

FIG. 1 is a schematic diagram of an embodiment of the present disclosure;

FIG. 2 and FIG. 3 are flow charts of a control method of a flocculation washing machine according to an embodiment of the present disclosure; and

FIG. 4 is a flow chart of determination of a number of times N of flocculation circulation according to an embodiment of the present disclosure.

### DETAILED DESCRIPTION

The present disclosure is further described below in detail with reference to embodiments.

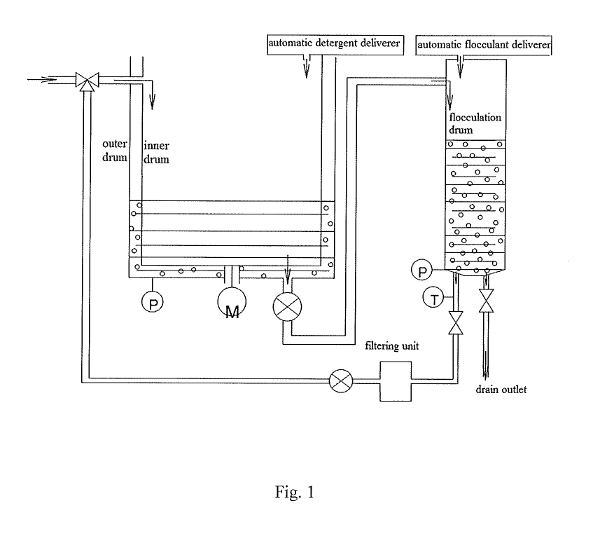

As shown in FIG. 1, a washing machine of the embodiment of the present disclosure is internally provided with a conventional washing machine structure and is also provided with a circulation water treatment device. The washing machine structure comprises an outer drum, an inner drum disposed inside the outer drum, a door body, a control panel, a water intake system and a washing motor, the bottom and an upper part of the outer drum are connected with a casing frame through a damper and a suspension spring, respectively, and the water intake system comprises a water intake structure and an automatic detergent delivering device. The outer drum is a containing structure for containing washing water, and the inner drum disposed inside the outer drum is a washing structure. The outer drum is in communication with the water intake structure.

In the embodiments of the present disclosure, a flow sensor is arranged on the water intake structure of the washing machine and/or a liquid level sensor is disposed in the outer drum to detect an amount of washing water V; and a flow sensor is arranged on the automatic detergent deliverer to detect an amount of detergent delivered m.

In the embodiments of the present disclosure, the circulating water treatment device at least comprises a flocculation treatment unit; the flocculation treatment unit comprises a flocculation drum in communication with the outer drum and a flocculant deliverer by which a flocculant is delivered into the flocculation drum, and water is drained from the outer drum into the flocculation drum for flocculation treatment.

A liquid level sensor is disposed in the flocculation drum and/or a flow sensor is arranged on a pipe, connected with the outer drum, of the flocculation drum to detect an amount of water in the flocculation drum; and a flow sensor is arranged on the automatic flocculant deliverer to detect a dose of flocculant delivered.

The flocculation drum is provided with a water inlet, a water return opening and a drain outlet; a water outlet of the outer drum is in communication with the water inlet of the flocculation drum through a pipe equipped with a first water pump, and the water return opening of the flocculation drum is in communication with a water inlet of the outer drum through a pipe equipped with a second water pump, thereby forming a controllable circulation loop of washing water between the outer drum and the flocculation drum. The drain outlet of the flocculation drum is in communication with the external of the washing machine through a pipe equipped with a drainage valve, and the drain outlet drains out sewage and flocculates after washing is completed.

Preferably, the circulating water treatment device further comprises a filtering unit; the filtering unit performs filtering treatment on water after flocculation treatment in the flocculation treatment unit to separate flocculates from clean water. However, flocculates can also be separated from clean water without a filtering device, for example, a water level sensor is disposed in the flocculation drum to ensure that the water level of the flocculation drum always keeps a certain height, so that flocculates floating on the water surface of the flocculation drum are always left in the flocculation drum, and the purpose of removing flocculates in flocculation water is also achieved.

In the embodiments of the present disclosure, an amount of the washing water V and an amount of the detergent delivered m in the washing procedure are obtained by detection, and a concentration of the detergent C is obtained according to C=m/V. And a number of times N of flocculation circulation and a dose of the flocculant delivered corresponding to each flocculation circulation Mₙ are determined according to the concentration of detergent C.

By the above modes, different flocculation treatment processes are matching with different washing procedures, and the dose of the flocculant delivered is accurately controlled to prevent a condition that flocculates cannot be stratified from occurring. Besides, the number of times of flocculation circulation is also accurately determined to prevent a condition that the detergent is treated incompletely or the number of times of flocculation circulation is excessive to waste electric power from occurring. Further, in the present disclosure, the number of times N of flocculation circulation and the dose Mₙ of the flocculant delivered corresponding to each flocculation circulation can be obtained accurately only based on the concentration of the detergent in the washing procedure, and the accurate control on the flocculation treatment processes of the washing machine is achieved.

### Embodiment 1

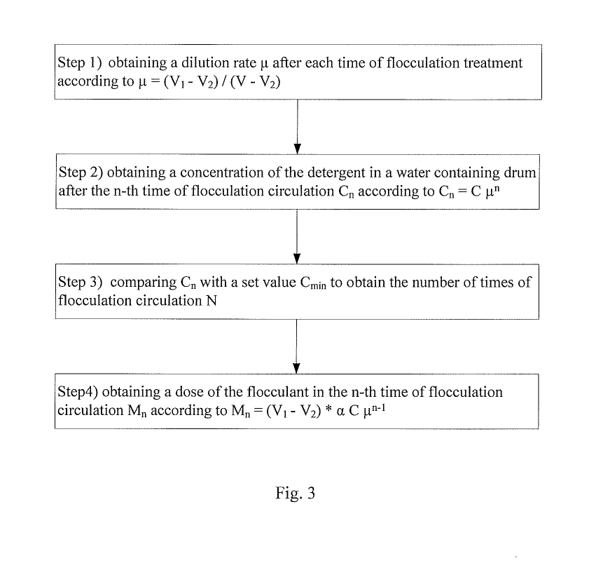

As shown in FIG. 3, in this embodiment, specific steps for determining a number of times N of flocculation circulation and a dose of a flocculant delivered corresponding to each flocculation circulation Mₙ are as follows:

1) an amount of washing water V is selected by a user and/or detected by a washing machine to invoke a corresponding amount V₁ of water in each flocculation circulation and an amount V₂ of residual water after treatment and returning; and a dilution rate μ in each flocculation circulation is obtained according to μ=(V₁−V₂)/(V−V₂);

2) a concentration Cₘᵢₙ of a detergent in an outer drum after the n-th time of flocculation circulation is obtained according to Cₙ=C μⁿ (n is any integer larger than 0);

3) Cₙ is compared with a set value Cₘᵢₙ to obtain the number of times N of flocculation circulation; and

4) a dose of the flocculant delivered in the n-th time of flocculation circulation Mₙ is obtained according to Mₙ=(V₁−V₂)*α C μⁿ⁻¹.

In this embodiment, the amount V₂ of the residual water after treatment and returning in the flocculation drum does not exist before the very first time of flocculation circulation, so that, a special condition exists in step 4). Namely the dose of the flocculant delivered in the first time of flocculation circulation M₁=α m V₁/V=V₁ α C; and the dose of the flocculant delivered in other times of flocculation circulation is still equal to the dose of the flocculant delivered in the n-th time of flocculation circulation Mₙ=(V₁−V₂)*α C μⁿ⁻¹ (Mₙ includes M₂ corresponding to the second time of flocculation circulation, . . . and Mₙ corresponding to the n-th time of flocculation circulation).

In this embodiment, the amount of water treated in flocculation circulation is an amount of water in the flocculation drum during the flocculation treatment. The amount V₁ of water treated in each flocculation circulation is the maximum capacity of the flocculation drum when the amount of the washing water V is larger than a set value; and the amount V₁ of water treated in each flocculation circulation is ⅘ to ½ of the maximum capacity of the flocculation drum when the amount of the washing water V is smaller than the set value. Preferably, V₁ is ⅘ of the maximum capacity of the flocculation drum.

In this embodiment, the amount V₂ of residual water after treatment and returning is a set value which is smaller than ½ of the maximum capacity of the flocculation drum; and preferably, V₂ is a set value between 0.5 L and 3 L.

In this embodiment, in step 4), α is a corresponding set value according to characteristics of the detergent and the flocculant. Preferably, a includes a plurality of different values α₁, α₂, α₃, α₄, . . . and αₘ stored in the washing machine; and each value respectively corresponds to different types of detergents and flocculants to improve the determination accuracy.

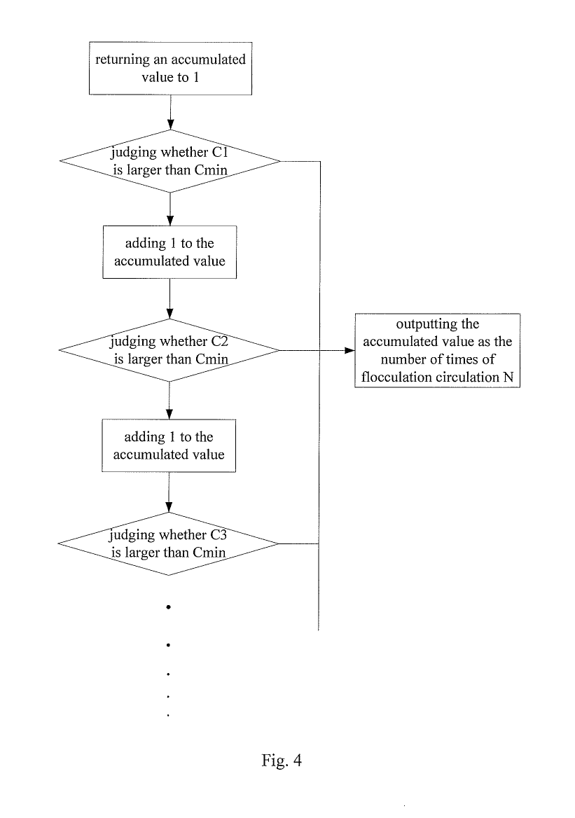

As shown in FIG. 4, in this embodiment, the number of times N of flocculation circulation is obtained in step 3) as follows: a value Cₙ closest to the set value Cₘᵢₙ and smaller than Cₘᵢₙ is determined, and then the number of times N of flocculation circulation is n corresponding to the determined value. Specific determination steps are as follows:

31) an accumulated value is initialized and is returned to 1;

32) C₁ is compared with the set value Cₘᵢₙ, and step 30) is executed if C₁ is larger than the set value Cₘᵢₙ; otherwise, the accumulated value adds 1 and step 33) is executed;

32) C₂ is compared with the set value Cₘᵢₙ, and step 30) is executed if C₂ is larger than the set value Cₘᵢₙ; otherwise, the accumulated value adds 1 and step 34) is executed, . . . ;

30) the accumulated value at this time is taken as the number of times N of flocculation circulation and is outputted.

By the above modes, the corresponding Cₙ closest to the set value Cₘᵢₙ and smaller than Cₘᵢₙ can be quickly determined, and the corresponding number of times N of flocculation circulation can be obtained. Therefore, the concentration of the detergent in the washing drum is smaller than the set value after the flocculation treatment circulates for N times, thereby achieving the purpose of removing detergent residual on the clothes. Besides, an end time node of a rinsing procedure can be accurately controlled through the above determination, improving the control accuracy of the washing machine.

### Embodiment 2

In this embodiment, after the washing procedure of the washing machine ends, a rinsing procedure starts running by utilizing the washing water, and simultaneously the washing water is subjected to N times of flocculation circulation, wherein the flocculant is delivered into the flocculation drum in an amount of Mₙ in each flocculation circulation.

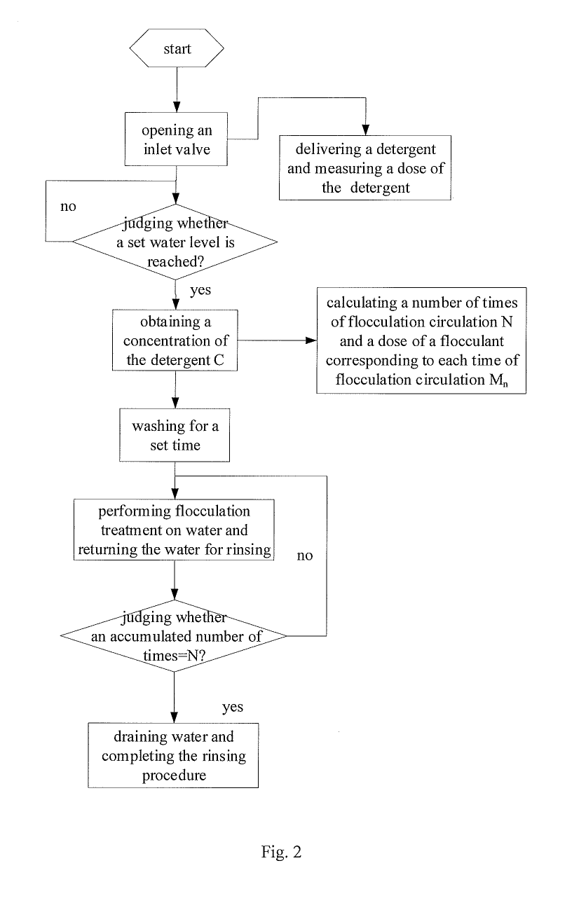

As shown in FIG. 2, a specific working process of the washing machine is as follows:

S1) an amount of the washing water V and an amount of the detergent delivered m are obtained by detection after the washing machine starts running the washing procedure, and a concentration of the detergent C is obtained according to C=m/V;

S2) the number of times N of flocculation circulation of washing water and a dose Mₙ of the flocculant delivered corresponding to each flocculation circulation are determined according to the concentration of the detergent C;

S3) the washing procedure ends, the washing water in the outer drum flows into the flocculation drum until the amount V₁ of washing water in the flocculation drum is, and the flocculant is delivered into the flocculation drum in an amount of Mₙ; and after the washing water in the flocculation drum is subjected to flocculation treatment, water in the flocculation drum flows back to the outer drum until an amount of residual water in the flocculation drum is V₂;

S4) an accumulated value of the number of times of flocculation circulation adds 1, and whether the accumulated value reaches N or not is determined; if not, step S3) is continuously executed, and the accumulated value is substituted as n; and if so, step S6) is executed;

S5) the rinsing procedure starts running by utilizing the washing water in the outer drum while step S3) and step S4) are executed; and

S6) the rinsing procedure ends, water in the outer drum and the flocculation drum is completely drained out, and the flocculation drum is cleaned.

In this embodiment, the number of times N of flocculation circulation and the dose Mₙ of the flocculant delivered corresponding to each flocculation circulation are obtained in step S2) according to the determination method from step 1) to step 4) in the embodiment 1.

By the above modes, the flocculation treatment and the rinsing procedure of the washing machine are synchronously executed, and at an end node, the concentration of the detergent in the outer drum is lower than the set value, thereby achieving the purpose of removing detergent residual on the clothes; and further, the dose of the flocculant and the number of times of flocculation circulation are accurately controlled, thereby improving the control accuracy of the flocculation treatment process of the washing machine.

The implementation solutions in the above embodiments are only for describing preferred embodiments of the present disclosure and are not intended to limit the concept and scope of the present disclosure, without departing from the design concept of the present disclosure, various changes and modifications made by those skilled in the art to the technical solutions shall all be covered within the scope of the present disclosure.

1. A control method of a flocculation washing machine, comprising: acquiring an amount of washing water V and an amount of a detergent delivered m in a washing procedure to obtain a concentration of the detergent C=m/V;
determining a number of times N of flocculation circulation of the washing water and a dose of a flocculant Mₙ corresponding to each flocculation circulation according to the concentration of the detergent C.

2. The method according to claim 1 comprising the following specific steps,
1) obtaining the amount of the washing water V by a selection of a user and/or a detection of the washing machine, and invoking a corresponding amount V₁ of water treated in each flocculation circulation and an amount V₂ of residual water after treatment and returning;
and obtaining a dilution rate p after each flocculation treatment according to μ=(V₁−V₂)/(V−V₂);
2) obtaining a concentration of the detergent Cₙ in an outer drum after a n-th time of flocculation circulation according to Cₙ=C μⁿ, which n is any integer larger than 0;
3) comparing Cₙ with a set value Cₘᵢₙ to obtain the number of times N of flocculation circulation; and
4) obtaining a dose of the flocculant Mₙ delivered in the n-th time of flocculation circulation according to Mₙ=(V₁−V₂)*α C μⁿ⁻¹.

3. The method according to claim 2, wherein, the amount V₁ of water treated in each flocculation circulation is a maximum capacity of a flocculation drum when the amount of the washing water V is larger than a set value; and
the amount V₁ of water treated in each flocculation circulation is ⅘ to ½ of the maximum capacity of the flocculation drum when the amount of the washing water V is smaller than the set value.

4. The method according to claim 2, wherein, the amount V₂ of the residual water after treatment and returning is an amount of residual water in a flocculation drum after the flocculation treatment, and V₂ is a set value smaller than ½ of a maximum capacity of the flocculation drum.

5. The method according to claim 2, wherein, a value Cₙ closest to the set value Cₘᵢₙ and smaller than Cₘᵢₙ is determined, and then the number of times N of flocculation circulation is n corresponding to the value determined.

6. The method according to claim 2, wherein, in step 4), a dose M₁ of the flocculant delivered in a first time of flocculation circulation satisfies M₁=α m V₁/V=V₁ α C.

7. The method according to claim 1, wherein, after the washing procedure of the washing machine ends, a rinsing procedure starts running by utilizing the washing water, and simultaneously the washing water is subjected to N times of flocculation circulation, and the flocculant is delivered into the flocculation drum in an amount Mₙ of in each flocculation circulation.

8. The method according to claim 7, wherein, a specific working process of the washing machine is as follows:
S1) obtaining the amount of the washing water V and the amount of the detergent delivered m by detection after the washing machine starts running the washing procedure, and obtaining the concentration of the detergent C according to C=m/V;
S2) determining the number of times N of flocculation circulation of the washing water and the dose Mₙ of the flocculant delivered corresponding to each flocculation circulation according to the concentration of the detergent C;
S3) after the washing procedure ends, allowing the washing water in an outer drum to flow into the flocculation drum until the amount V₁ of washing water in the flocculation drum is, delivering the flocculant in the amount of Mₙ into the flocculation drum, performing flocculation treatment on the washing water in the flocculation drum, and thereafter allowing water in the flocculation drum to flow back to the outer drum until an amount V₂ of residual water in the flocculation drum is;
S4) adding 1 to the number of times of flocculation circulation to get an accumulated value, and determining whether the accumulated value reaches N or not; if not, continuously executing step S3) while substituting the accumulated value into step S3) as n; and if yes, executing step S6);
S5) starting running the rinsing procedure by utilizing the washing water in the outer drum while executing step S3) and step S4); and
S6) after the rinsing procedure ends, completely draining out water in the outer drum and the flocculation drum, and cleaning the flocculation drum.

9. A washing machine adopting the control method according to claim 1, wherein, a flow sensor is arranged on a water intake structure of the washing machine and/or a liquid level sensor is disposed in an outer drum to detect an amount of washing water V; and a flow sensor is arranged on an automatic detergent deliverer to detect an amount of a detergent delivered m.

10. The washing machine according to claim 7, wherein, a liquid level sensor disposed in the flocculation drum and/or a flow sensor is arranged on a pipe for connecting the outer drum with the flocculation drum to detect an amount of water in the flocculation drum; and
a flow sensor is arranged on an automatic flocculant deliverer to detect a dose of a flocculant.

11. The method according to claim 2, wherein, after the washing procedure of the washing machine ends, a rinsing procedure starts running by utilizing the washing water, and simultaneously the washing water is subjected to N times of flocculation circulation, and the flocculant is delivered into the flocculation drum in an amount Mₙ of in each flocculation circulation.

12. The washing machine adopting the control method according to claim 2, wherein, a flow sensor is arranged on a water intake structure of the washing machine and/or a liquid level sensor is disposed in an outer drum to detect the amount of washing water V; and a flow sensor is arranged on an automatic detergent deliverer to detect the amount of a detergent delivered m.

13. The washing machine adopting the control method according to claim 7, wherein, a flow sensor is arranged on a water intake structure of the washing machine and/or a liquid level sensor is disposed in an outer drum to detect the amount of washing water V; and a flow sensor is arranged on an automatic detergent deliverer to detect the amount of a detergent delivered m.
